(19) United States
(12) Patent Application Publication
(10) Pub. No.: US 2021/0304951 A1
(43) Pub. Date: Sep. 30, 2021

(54) METHOD OF MANUFACTURING COIL COMPONENT

(71) Applicant: TAIYO YUDEN CO., LTD., Tokyo (JP)

(72) Inventors: Yoshikazu MARUYAMA, Tokyo (JP); Osamu TAKAHASHI, Tokyo (JP)

(21) Appl. No.: 17/212,647

(22) Filed: Mar. 25, 2021

(30) Foreign Application Priority Data
Mar. 27, 2020 (JP) 2020-059075

(51) Int. Cl. H01F 27/28; H01F 17/00; H01F 41/04

(52) U.S. Cl. CPC H01F 27/2804; H01F 17/0013; H01F 2017/0066; H01F 2027/2809; H01F 41/041

(57) ABSTRACT

A manufacturing method of a coil component according to one or more embodiments includes a step of forming a conductor pattern on a magnetic sheet from a conductive paste containing conductive particles, organic particles made of an organic material, and a binder resin; a step of laminating a plurality of the magnetic sheets on which the conductor pattern has been formed to form a laminate; a first heating step of heating the laminate at a first temperature that is equal to or higher than a decomposition temperature of the binder resin, equal to or higher than a sintering onset temperature of the conductive particles, and lower than a thermal decomposition temperature of the organic particles; and a second heating step of heating the laminate at a second temperature higher than the thermal decomposition temperature of the organic particles. The conductive paste may include inorganic particles made of an inorganic material.

### CROSS-REFERENCE TO RELATED APPLICATIONS

This application is based on and claims the benefit of priority from Japanese Patent Application Serial No. 2020-59075 (filed on Mar. 27, 2020), the contents of which are hereby incorporated by reference in its entirety.

### TECHNICAL FIELD

The present invention relates to a coil component.

### BACKGROUND

A coil component including a magnetic layer formed of a magnetic material and a conductor pattern formed on the magnetic layer has been known. As one conventional coil component, also known is a multilayer coil component in which a plurality of magnetic layers having conductor patterns thereon are laminated on top of each other. One example of such a multilayer coil component is a multilayer inductor. The multilayer inductor is a passive element used in an electric circuit. For example, the multilayer inductor is used to eliminate noise in a power source line or a signal line. Conventional multilayer coil components are described in, for example, Japanese Patent Application Publication No. 2007-027353 and Japanese Patent Application Publication No. 2012-238840.

A conventional manufacturing process of the multilayer coil component typically includes a step of fabricating a laminate by printing a conductive paste, which is a mixture of metal particles such as Ag particles and a binder resin, on a magnetic sheet made of a magnetic material, and laminating two or more such magnetic sheets on which the conductive paste is printed. The manufacturing process further includes a step of heat-treating the laminate.

Ag particles may be sintered ata low temperature of less than 250° C., although the temperature may be changed depending on the particle size. Further, as the binder resin, a resin material having a thermal decomposition temperature of about 250° C. is often used. For example, the thermal decomposition temperature of an epoxy resin widely used as the binder resin is approximately 250° C. When the conductive paste containing metal particles such as Ag particles that are to be sintered at a low temperature is heated to a temperature higher than the thermal decomposition temperature of the binder resin during the heat treatment in the manufacturing process, both the thermal decomposition of the binder resin and the sintering of the metal particles such as Ag particles that are to be sintered at a low temperature proceed at the same time. Therefore, the product of the thermal decomposition of the binder resin may not be discharged to the outside of the conductive paste but may be trapped in the sintered body of metal particles such as Ag particles that are sintered at a low temperature. When the temperature is further raised, the binder resin residue in the sintered body expands, and the sintered body also expands accordingly. The expansion of the sintered body may cause troubles such as cracks in the magnetic layer situated next to the sintered body and delamination of the sintered body from the magnetic layer. The occurrence of such cracks in the magnetic body in contact with the sintered body and delamination of the sintered body from the magnetic body is increased when the heat treatment of the laminated boy is performed at a high temperature.

### SUMMARY

One object of the present invention is to overcome at least a part of the above drawback. One more specific object of the invention is to suppress the expansion of the sintered body in the conductive paste of which temperature rises during the heat treatment. Other objects of the present invention will be made apparent through the entire description in the specification. The invention disclosed herein may address other drawbacks in addition to the drawback described above.

A method of manufacturing a coil component according to one aspect of the invention includes: a step of forming, on a magnetic sheet, a conductor pattern from a conductive paste that contains conductive particles, organic particles made of an organic material, and a binder resin; a step of laminating a plurality of magnetic sheets on which the conductor pattern has been formed to obtain a laminate; a first heating step of heating the laminate at a first temperature, the first temperature being equal to or higher than a decomposition temperature of the binder resin, equal to or higher than a sintering onset temperature of the conductive particles, and lower than a thermal decomposition temperature of the organic particles; and a second heating step of heating the laminate at a second temperature, the second temperature being higher than the thermal decomposition temperature of the organic particles.

In one or more embodiments of the invention, the organic material may be an acrylic resin.

In one or more embodiments of the invention, a content ratio of the organic particles to a total mass of the conductive particles and the organic particles is 1.0 to 5.0 wt %.

In one or more embodiments of the invention, the second temperature is 800° C. or higher.

A method of manufacturing a coil component according to another aspect of the invention includes: a step of forming, on a magnetic sheet, a conductor pattern from a conductive paste that contains conductive particles, inorganic particles made of an inorganic material, and a binder resin; a step of forming, on a magnetic sheet, a conductor pattern from a conductive paste that contains conductive particles, organic particles made of an organic material, and a binder resin; a first heating step of heating the laminate at a first temperature, the first temperature being equal to or higher than a decomposition temperature of the binder resin, equal to or higher than a sintering onset temperature of the conductive particles, and lower than a melting point of the inorganic particles; and a second heating step of heating the laminate at a second temperature, the second temperature being higher than the first temperature.

In one or more embodiments of the invention, the inorganic material is zirconia.

In one or more embodiments of the invention, a content ratio of the inorganic particles to a total mass of the conductive particles and the inorganic particles is 0.05 to 0.15 wt %.

In one or more embodiments of the invention, the laminate is heated at 800° C. or higher in the heating step.

In one or more embodiments of the invention, the plurality of magnetic sheets include a first magnetic sheet and a second magnetic sheet disposed on the first magnetic sheet, a first conductor pattern is formed from the conductive paste on an upper surface of the first magnetic sheet, and a second conductor pattern is formed from the conductive paste on an upper surface of the second magnetic sheet. A thickness of the first conductor pattern is larger than a distance between the first conductor pattern and the second conductor pattern.

In one or more embodiments of the invention, the conductive particles are silver particles.

The method of manufacturing a coil component according to one or more embodiments of the invention may further include a step of providing a first external electrode at one end of the conductor pattern and providing a second external electrode at the other end of the conductor pattern.

### ADVANTAGEOUS EFFECTS

According to one or more embodiments of the invention, it is possible to suppress the expansion of the sintered body in the conductive paste of which temperature rises during the heat treatment.

### BRIEF DESCRIPTION OF THE DRAWINGS

FIG. 1 is a perspective view of a coil component mounted on a circuit board.

FIG. 2 is an exploded view of the coil component of FIG. 1.

FIG. 3 is a sectional view of the coil component of FIG. 1 along the line I-I.

FIG. 4 is an enlarged schematic sectional view of a region A of FIG. 3.

### DESCRIPTION OF THE EMBODIMENTS

Various embodiments of the present invention will be hereinafter described with reference to the accompanying drawings. Reference characters designating corresponding components are repeated as necessary throughout the drawings for the sake of consistency and clarity. For convenience of explanation, the drawings are not necessarily drawn to scale.

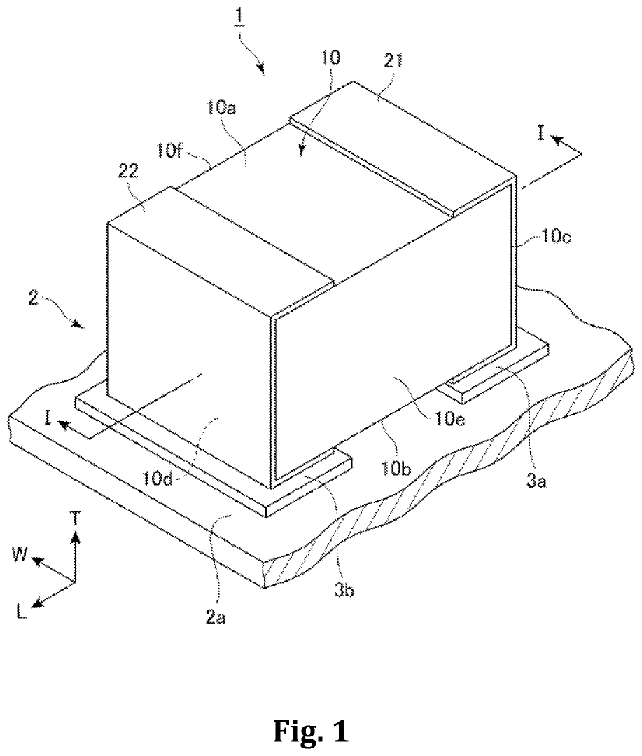

A coil component 1 according to one embodiment of the invention will be hereinafter described with reference to FIGS. 1 to 3. The coil component 1 is an example of the coil component manufactured by the manufacturing method according to the invention. In the illustrated embodiment, the coil component 1 is a multilayer inductor. This multilayer inductor can be used as a power inductor incorporated in a power supply line and various other inductors. The invention can be applied to various coil components other than the illustrated multilayer inductor.

As shown, the coil component 1 includes a base body 10, a coil conductor 25 provided in the base body 10, an external electrode 21 disposed on a surface of the base body 10, and an external electrode 22 disposed on a surface of the base body 10 at a position spaced from the external electrode 21.

The coil component 1 is mounted on a mounting substrate 2a. A circuit board 2 includes the coil component 1 and the mounting substrate 2a having the coil component 1 mounted thereon. The mounting substrate 2a has two land portions 3 provided thereon. The coil component 1 is mounted on the mounting substrate 2a by bonding the external electrodes 21, 22 to the corresponding land portions 3 of the mounting substrate 2a. The circuit board 2 may include any other electronic components in addition to the coil component 1.

The circuit board 2 can be installed in various electronic devices. The electronic devices in which the circuit board 2 may be installed include smartphones, tablets, game consoles, electrical components of automobiles, and various other electronic devices. Electronic device in which the coil component 1 is mounted is not limited to those explicitly described herein.

In one or more embodiments of the invention, the base body 10 may have a substantially rectangular parallelepiped shape and be formed of a magnetic material. The base body 10 has a first principal surface 10a, a second principal surface 10b, a first end surface 10c, a second end surface 10d, a first side surface 10e, and a second side surface 10f. These six surfaces define the outer periphery of the base body 10. The first principal surface 10a and the second principal surface 10b are opposed to each other, the first end surface 10c and the second end surface 10d are opposed to each other, and the first side surface 10e and the second side surface 10f are opposed to each other. As shown in FIG. 1, the first principal surface 10a lies on the top side in the base body 10, and therefore, the first principal surface 10a may be herein referred to as “the top surface.” Similarly, the second principal surface 10b may be referred to as “the bottom surface.” The magnetic coupling coil element 1 is disposed such that the second principal surface 10b faces the circuit board 2, and therefore, the second principal surface 10b may be herein referred to as “the mounting surface.” The top-bottom direction of the coil component 1 mentioned herein refers to the top-bottom direction in FIG. 1. In this specification, a “length” direction, a “width” direction, and a “height” direction of the coil component 1 correspond to the “L axis” direction, the “W axis” direction, and the “T axis” direction in FIG. 1, respectively, unless otherwise construed from the context. The L axis, the W axis, and the T axis are perpendicular to one another. The coil axis Ax extends in the T axis direction. The coil axis Ax extends in a direction perpendicular to the first principal surface 10a that has a rectangular shape in a plan view, and passing through the intersection of the diagonal lines of the first principal surface 10a, for example.

In one or more embodiments of the invention, the coil component 1 has a length (the dimension in the direction of the L axis) of 0.2 to 6.0 mm, a width (the dimension in the direction of the W axis) of 0.1 to 4.5 mm, and a height (the dimension in the direction of the T axis) of 0.1 to 4.0 mm. These dimensions are mere examples, and the coil component 1 to which the present invention is applicable can have any dimensions that conform to the purport of the present invention. In one or more embodiments, the coil component 1 has a low profile. For example, the coil component 1 has a width larger than a height thereof.

As mentioned above, the base body 10 is formed of a magnetic material in one or more embodiments of the invention. For example, the base body contains a plurality of metal magnetic particles. The metal magnetic particles are particles or powder of a soft magnetic metal material. Such a soft magnetic metal material for the metal magnetic particles may be, for example, (1) Fe or Ni; (2) Fe-Si-Cr based alloy, Fe—Si—Al based alloy, or Fe—Ni alloy; (3) Fe—Si—Cr—B—C amorphous alloy, or Fe—Si—B—Cr amorphous alloy; or (4) a material of any combination thereof. The average particle size of the metal magnetic particles is, for example, 1 μm to 20 μm. The average particle size of the metal magnetic particles is not limited to the range of 1 μm to 20 μm and can be changed as appropriate. In one or more embodiments, the metal magnetic particles exhibit a spherical or substantially spherical shape. The Fe content in the metal magnetic particles may be 85 wt % or larger. An insulating film is formed on surfaces of the metal magnetic particles included in the base body 10. The insulating film on the surfaces of the metal magnetic particles may be, for example, an oxide film formed by oxidizing the surfaces of the metal magnetic particles. An insulating coating film may be formed on the surfaces of the metal magnetic particles. The coating film may be, for example, a thin film made of or containing silica.

The base body 10 may contain a binder for strengthening the bond between the metal magnetic particles. More specifically, the binder contained in the base body 10 can be a thermosetting resin having an excellent insulating property such as an epoxy resin, a phenolic resin, a polyimide resin, a silicone resin, polystyrene (PS) resin, a high density polyethylene (HDPE) resin, a polyoxymethylene (POM) resin, a polycarbonate (PC) resin, a polyvinylidene fluoride (PVDF) resin, a phenolic resin, a polytetrafluoroethylene (PTFE) resin, a polybenzoxazole (PBO) resin, a polyvinyl alcohol (PVA) resin, a polyvinyl butyral (PVB) resin, and an acrylic resin.

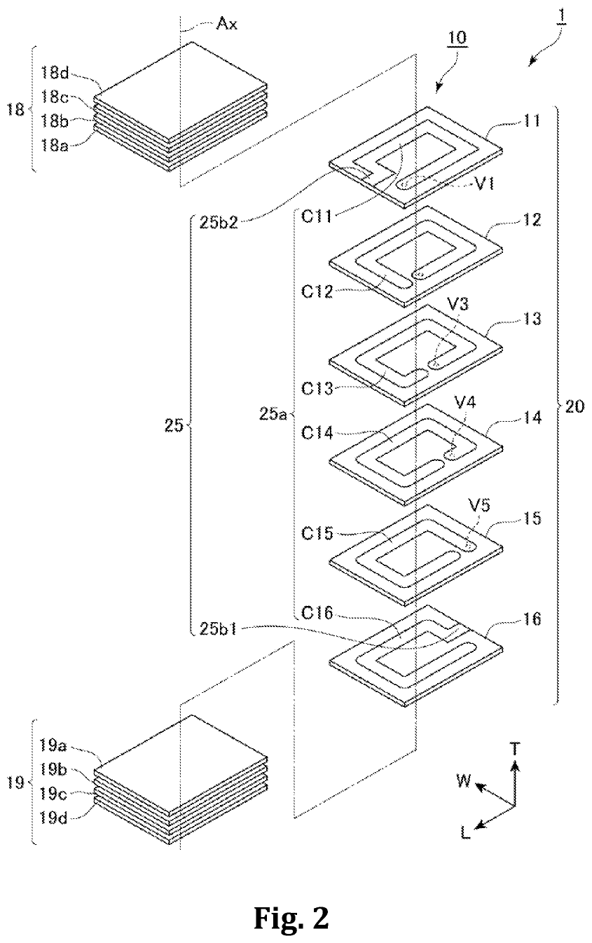

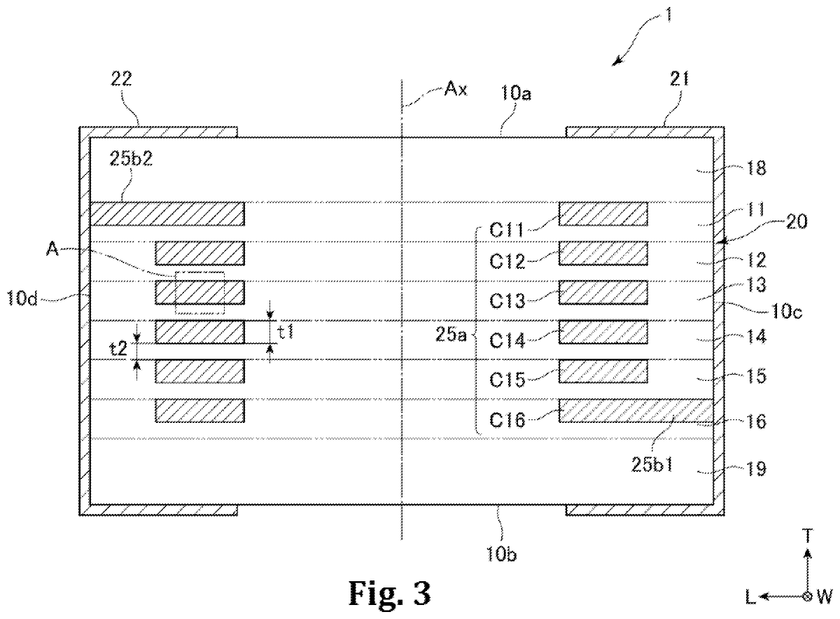

As shown in FIGS. 2 and 3, the base body 10 includes a plurality of magnetic layers stacking on top of each other. As shown, the base body 10 includes a body portion 20, a top cover layer 18 provided on the top surface of the body portion 20, and a bottom cover layer 19 provided on the bottom surface of the body portion 20. The body portion 20 includes magnetic layers 11 to 16 stacked together. The base body 10 includes the top cover layer 18, the magnetic layer 11, the magnetic layer 12, the magnetic layer 13, the magnetic layer 14, the magnetic layer 15, the magnetic layer 16, and the bottom cover layer 19 that are stacked in this order from the top to the bottom as shown in FIG. 2.

The top cover layer 18 includes four magnetic layers 18a to 18d. The top cover layer 18 includes the magnetic layer 18a, the magnetic layer 18b, the magnetic layer 18c, and the magnetic layer 18d that are stacked in this order from the bottom to the top in FIG. 2.

The bottom cover layer 19 includes four magnetic layers 19a to 19d. The bottom cover layer 19 includes the magnetic layer 19a, the magnetic layer 19b, the magnetic layer 19c, and the magnetic layer 19d that are stacked in this order from the top to the bottom in FIG. 2.

The coil component 1 may include any number of magnetic layers as necessary in addition to the magnetic layers 11 to 16, the magnetic layers 18a to 18d, and the magnetic layers 19a to 19d. Some of the magnetic layers 11 to 16, the magnetic layers 18a to 18d, and the magnetic layers 19a to 19d can be omitted as appropriate. Although the boundaries between the magnetic layers are shown in FIG. 3, the boundaries between the magnetic layers may not be visible in the base body of the actual coil component to which the invention is applied.

Each of conductor patterns C11 to C14 is electrically connected to the respective adjacent conductor patterns through vias V1 to V4. The conductor patterns C11 to C14 connected in this manner form a spiral winding portion 25a. In other words, the winding portion 25a of the coil conductor 25 includes the conductor patterns C11 to C15 and the vias V1 to V4.

The magnetic layers 11 to 16 have the patterns C11 to C16 formed thereon, respectively. The conductor patterns C11 to C16 constitute the winding portion 25a. The conductor patterns C11 to C16 extend around the coil axis Ax. In the embodiment shown, the coil axis Ax extends in the T axis direction, which is the same as the lamination direction of the magnetic layers 11 to 16.

An end of the conductor pattern C11 opposite to an end thereof connected to the via V1 is connected to an external electrode 22 via a lead-out conductor 25b2. An end of the conductor pattern C16 opposite to an end thereof connected to the via V5 is connected to an external electrode 21 via a lead-out conductor 25b1. As described above, the coil conductor 25 includes the winding portion 25a, the lead-out conductor 25b1, and the lead-out conductor 25b2.

The conductor patterns C11 to C17 are formed on the corresponding magnetic layers 11 to 16, respectively. The conductor patterns C11 to C16 are formed by applying a conductive paste onto a magnetic sheet such that the shapes of the conductor patterns C11 to C16 are formed thereon as described later, and heating the conductive paste on the magnetic sheet. The magnetic layers 11 to 15 are provided with the vias V1 to V5, respectively, at predetermined locations therein. The vias V1 to V5 are formed by forming a through-hole at the predetermined position in the magnetic layers 11 to 15 so as to extend through the magnetic layers 11 to 15 in the T axis direction and filling the through-holes with a conductive material. The conductor patterns C11 to C16 and the vias V1 to V5 contain metal having an excellent electrical conductivity, such as Ag. As a metal material having excellent conductivity for the conductor patterns C11 to C16 and vias V1 to V5, an alloy containing Cu or Ag as a main component and an alloy containing Cu as a main component can be used in addition to Ag.

As described above, the coil conductor 25 has the winding portion 25a extending around the coil shaft Ax and is arranged in the base body 10. In the coil conductor 25, the end portions of the lead-out conductor 25b1 and the lead-out conductor 25b2 are exposed from the base body 10 to the outside, but the rest of the coil conductor 25 is disposed inside the base body 10.

In one or more embodiments of the invention, a thickness of each of the conductor patterns C11 to C16 is greater than a spacing between respective adjacent conductor patterns C11 to C16. For example, as shown in FIG. 3, a thickness t1 of the conductor pattern C14 is larger than a distance t2 between the conductor pattern C14 and the conductor pattern C15 adjacent thereto. This magnitude relationship may hold not only for the spacing between the conductor pattern C14 and the conductor pattern C15, but also for other adjacent sets of the conductor patterns.

Next, a description is given of an example of a method of manufacturing the coil component 1. The coil component 1 is manufactured, for example, by a sheet manufacturing method using the magnetic sheets. A method of manufacturing a coil component according to one or more embodiments of the invention includes a step of preparing a magnetic sheet on which a conductor pattern is formed by forming the conductor pattern on the magnetic material (referred to as a “sheet preparation step”), a step of forming a laminate by laminating a plurality of the magnetic sheets on which the conductor pattern is formed (referred to as a “lamination step”), and a step of heating the laminate (referred to as a “heating step”). The following describes each of these steps in detail. As will be described in detail later, the conductor pattern formed on the magnetic sheet in the sheet preparation step is formed from a conductive paste. This conductive paste contains a sintering inhibitor for inhibiting the sintering of conductive particles during thermal decomposition of the binder resin and promoting discharge of the product of the thermal decomposition to the outside. The conductive paste can contain organic particles or inorganic particles as the sintering inhibitor. In the following description, an embodiment in which the conductive paste contains organic particles will be first described followed by an embodiment in which the conductive paste contains inorganic particles.

The sheet preparation step in the method according to the embodiment where the conductive paste contains organic particles will be now described. In the sheet preparation step, a plurality of magnetic sheets containing a magnetic material are prepared. The magnetic sheet is produced, for example, by pouring a slurry, which is obtained by kneading metal magnetic particles with a resin, into a molding die and applying a predetermined molding pressure thereon. The resin material kneaded together with the metal magnetic particles may be, for example, a polyvinyl butyral (PVB) resin, an epoxy resin, or any other resin materials having an excellent insulation property.

A conductive paste is applied to some of the magnetic sheets, and unfired conductor patterns that turn to be the conductor patterns C11 to C16 after firing are formed on the respective magnetic sheets. Through holes penetrating in the lamination direction are formed in each of the magnetic sheets. When the conductive paste is applied to the magnetic sheets, the conductive paste is embedded in the through holes and unfired vias that turn to be the vias V1 to V5 after firing are formed. The conductive paste is applied to the magnetic sheets by, for example, screen printing.

The conductive paste used in one or more embodiments of the invention includes the conductive particles, the organic particles made of an organic material, and the binder resin. The conductive paste is obtained by kneading a group of particles including the conductive particles and the organic particles with the binder resin. The conductive paste may contain a curing agent such as an amine-based epoxy curing agent and a solvent.

In one or more embodiments of the invention, the conductive particles contained in the conductive paste are particles containing a metal having excellent conductivity. The conductive particles are formed of, for example, Ag or an alloy containing Ag. In one or more embodiments of the invention, the average particle size of the Ag particles is 1 to 20 rim. A sintering onset temperature changes depending on the particle size of the Ag particles. In one or more embodiments of the invention, the particle size of the Ag particles is determined such that the sintering onset temperature of the Ag particles is lower than the thermal decomposition temperature of the organic particles. The sintering onset temperature of the conductive particles refers to a temperature at which the conductive particles shrink to some extent while the temperature of the conductive particles rises under a reducing atmosphere. The sintering onset temperature is herein defined as the temperature at which the volume of the aggregate of conductive particles shrinks by 1%. When the temperature of the aggregate of the conductive particles is elevated, gaps between the conductive particles become smaller, which causes shrinkage of the volume of the aggregate of the conductive particles. In one or more embodiments of the invention, the sintering onset temperature of the conductive particles is, for example, a temperature between 200° C. and 300° C. The term “average particle size” herein refers to a volume-based average particles size, unless otherwise construed. The volume-based average particle size of the soft magnetic metal particles is measured by the laser diffraction scattering method in conformity to JIS Z 8825. An example of the devices for the laser diffraction scattering method is the laser diffraction/scattering particle size distribution measuring device LA-960 from HORIBA Ltd., at Kyoto city, Kyoto, Japan.

In one or more embodiments of the invention, the organic particles contained in the conductive paste are particles of an organic material. As the organic material for organic particles, for example, acrylic resin, bakelite (phenolic resin), nylon resin, polyester resin, or polyethylene resin may be used. In one or more embodiments of the invention, the organic particles are formed of an organic material having a thermal decomposition temperature of 400° C. or higher.

In one or more embodiments of the invention, the average particle size of the organic particles is 1 to 30 μm. In one or more embodiments of the invention, the average particle size of the organic particles is 1 to 10 μm. The sintered body obtained by sintering the conductive particles includes voids between the organic particles. By reducing the particle size of the organic particles, the size of the voids in the sintered body can be reduced. By reducing the size of the voids in the sintered body, the conductivity of the coil conductor can be increased, and the chance of cracks in the coil conductor can be reduced.

In one or more embodiments of the invention, the content ratio of the organic particles to the total mass or 100 wt % of the conductive particles and the organic particles is 1.0 to 5.0 wt %.

Examples of the binder resin used in one or more embodiments of the invention may include an epoxy resin, a polyimide resin, a polystyrene (PS) resin, a high-density polyethylene (HDPE) resin, a polyoxymethylene (POM) resin, a polycarbonate (PC) resin, a polyvinylidene fluoride (PVDF) resin, a phenolic resin, a polytetrafluoroethylene (PTFE) resin, a polybenzoxazole (PBO) resin, any other known resins used as a binder resin, and mixtures thereof. The binder resin has a thermal decomposition temperature lower than the thermal decomposition temperature of the organic particles described above. As the binder resin, for example, a resin having a thermal decomposition temperature of 200 to 300° C. may be used.

Next, the lamination step will be now described. In the lamination step, an upper laminate that serves as the upper cover layer 18, an intermediate laminate, and a lower laminate that serves as the lower cover layer 19 are formed from the magnetic sheet produced in the sheet preparation step. The upper laminate and the lower laminate are each formed by stacking four magnetic sheets that have been prepared in the sheet preparation step and on which an unfired conductor pattern is not formed. The four magnetic sheets of the upper laminate serve as the magnetic layers 18a to 18d respectively in the finished coil component 1, and the four magnetic sheets of the lower laminate serve as the magnetic layers 19a to 19d respectively in the finished coil component 1. The intermediate laminate is formed by stacking magnetic sheets on which unfired conductor patterns are formed respectively in a predetermined order. The six magnetic sheets of the intermediate laminate serve as the magnetic layers 11 to 16 respectively in the finished coil component 1. The intermediate laminate formed in the above-described manner is sandwiched between the top laminate on the top side and the bottom laminate on the bottom side, and the top laminate and the bottom laminate are bonded to the intermediate laminate by thermal compression to obtain a body laminate. Next, the body laminate is diced into pieces of a desired size using a cutter such as a dicing machine or a laser processing machine to obtain chip laminates.

Next, the heating step will be now described. The heating step includes a first heating step in which the chip laminate is heated at a relatively low first temperature for a first heating time, and a second heating step in which the chip laminate is heated at a second temperature higher than the first temperature for a second heating time after the first heating step is performed. The first temperature is equal to or higher than the decomposition temperature of the binder resin contained in the unfired conductor pattern formed on the magnetic sheets of the chip laminate (that is, the binder resin contained in the conductive paste), equal to or higher than the sintering onset temperature of the conductive particles contained in the unfired conductor pattern, and lower than the thermal decomposition temperature of the organic particles. The thermal decomposition temperature of the binder resin (that is, the binder resin contained in the conductive paste) herein refers to a temperature at which the weight loss of the binder resin exceeds 80% while the temperature of the binder resin is elevated. The thermal decomposition temperature of the organic particles is construed in the same way. That is, the thermal decomposition temperature of the organic particles herein refers a temperature at which the weight loss of the organic particles exceeds 80% while the temperature of the organic particles is elevated. The first temperature is, for example, in the range of 300° C. or higher and lower than 400° C. By elevating the temperature of the chip laminate to the first temperature, thermal decomposition of the binder resin in the unfired conductor pattern progresses. The first heating time is defined a time that the binder resin is sufficiently thermally decomposed, and is set to, for example, 2 to 10 hours. The heating time for heating at the first temperature can be appropriately changed depending on the content of the binder resin, the type of the binder resin, and other factors.

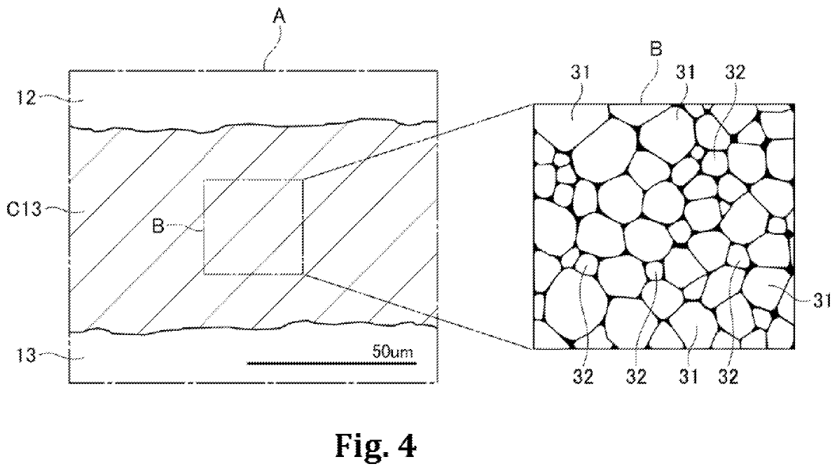

Since the first temperature is a temperature equal to or higher than the sintering onset temperature of the conductive particles, the sintering of the conductive particles also starts during the heat treatment performed at the first temperature. However, since the first temperature is lower than the thermal decomposition temperature of the organic particles, the organic particles are not thermally decomposed and remain between the conductive particles when heated at the first temperature. The organic particles hinder the progress of sintering of the conductive particles so that gaps remain between the conductive particles when heated at the first temperature. Products of the thermal decomposition of the binder resin, such as carbon dioxide, are discharged to the outside of the unfired conductor patterns through the gaps between the conductive particles during the heating step performed at the first temperature. FIG. 4 shows an enlarged view of a region corresponding to the region A of FIG. 3, which is a part of the chip laminate heated in the first heating step. The region A includes the conductor pattern C13, the magnetic layer 12, and a part of the magnetic layer 13. FIG. 4 also shows an enlarged view of a region B which is a part of the region A. Although FIG. 4 illustrates the unfired conductor pattern and the magnetic sheet before the heating step is completed, reference numerals indicating the conductor pattern C13, the magnetic layer 12, and the magnetic layer 13 after firing are used for convenience of explanation. As shown in FIG. 4, in the chip laminate that have been heated in the first heating step, the binder particles are thermally decomposed and the conductive particles 31 are in contact with each other and sintering of the conductive particles 31 has begun in the region corresponding to the conductor pattern. On the other hand, since the organic particles 32 are present between the conductive particles 31, the organic particles 32 hinder the progress of sintering of the conductive particles 31. Therefore, there are gaps between the conductive particles 31 particularly around the organic particles 32, and the product of the thermal decomposition of the binder resin is discharged to the outside of the conductive paste through these gaps.

The second heating step is subsequently performed. In the second heating step, the chip laminate is heated to a second temperature, and a heat treatment is performed at the second temperature for a second heating time. The second temperature is higher than the thermal decomposition temperature of the organic particles so that the organic particles are thermally decomposed during the heat treatment performed at the second temperature. The product produced by the thermal decomposition of the organic particles is discharged to the outside of the conductor pattern through the gaps left between the conductive particles. In one or more embodiments of the invention, the second temperature may be in the range of 800 to 900° C. The second heating time is determined as a time sufficient for obtaining a dense sintered body, for example, 1 to 2 hours. In the second heating step, the organic particles are also thermally decomposed, so that the sintering of the conductive particles that have been suppressed by the organic particles further progresses, and a dense sintered body can be obtained.

In the first heating step, the chip laminate may be heated to the first temperature and then may be maintained at the first temperature for the first heating time or immediately heated to the second temperature without maintaining at the first temperature for a certain time after the start of heating. In the latter case, the thermal decomposition of the binder resin will be completed before the temperature reaches to the second temperature after heating of the chip laminate is started.

Next, the external electrode 21 and the external electrode 22 are formed on the surface of the chip laminate to which the heat treatment has been performed. Through the above steps, the coil component 1 including the conductor patterns formed from the conductive paste containing the organic particles can be obtained.

A manufacturing method according to an embodiment where the conductive paste contains inorganic particles will be now described. The manufacturing method according to the embodiment where the conductive paste contains inorganic particles also includes a sheet preparation step, a lamination step, and a heating step. In the embodiment where the conductive paste contains inorganic particles, the conductive paste contains the inorganic particles instead of the organic particles, but other materials (for example, the material for the conductive particles and the material for the binder resin) may be the same as those in the embodiment where the conductive paste contains the organic particles. Therefore, in the following description, the embodiment where the conductive paste contains the inorganic particles will be described focusing on differences from the embodiment where the conductive paste contains the organic particles, and description of other elements will be omitted.

In the sheet preparation step, a plurality of magnetic sheets containing a magnetic material are prepared as in the above embodiment. A conductive paste is applied to some of the magnetic sheets, and unfired conductor patterns that turn to be the conductor patterns C11 to C16 after firing are formed on the respective magnetic sheets. The conductive paste includes the conductive particles, the inorganic particles made of an inorganic material, and the binder resin. The conductive paste is obtained by kneading a group of particles including the conductive particles and the inorganic particles with the binder resin. The conductive paste may contain a curing agent such as an amine-based epoxy curing agent and a solvent.

In one or more embodiments of the invention, the inorganic particles contained in the conductive paste are particles of an inorganic material. As the inorganic material for the inorganic particles, for example, zirconia, alumina, or silica may be used. As the inorganic material for the inorganic particles, for example, tungsten or molybdenum may be used. In one or more embodiments of the invention, the organic particles are formed of an inorganic material having a melting point of 400° C. or higher.

In one or more embodiments of the invention, the average particle size of the inorganic particles is 5 to 500 nm. In one or more embodiments of the invention, the average particle size of the inorganic particles is 5 to 100 nm. By reducing the particle size of the inorganic particles, the proportion of the inorganic particles in the sintered body can be reduced. By reducing the proportion of the inorganic particles in the sintered body, the conductivity of the coil conductor can be increased, and the chance of cracks in the coil conductor can be reduced.

In one or more embodiments of the invention, the content ratio of the inorganic particles to the total mass or 100 wt % of the conductive particles and the organic particles is 0.05 to 0.15 wt %.

In the lamination step, an upper laminate that serves as the upper cover layer 18, an intermediate laminate, and a lower laminate that serves as the lower cover layer 19 are formed from the magnetic sheet produced in the sheet preparation step. The intermediate laminate is subsequently sandwiched between the top laminate on the top side and the bottom laminate on the bottom side, and the top laminate and the bottom laminate are bonded to the intermediate laminate by thermal compression to obtain a body laminate. Next, the body laminate is diced into pieces of a desired size using a cutter such as a dicing machine or a laser processing machine to obtain chip laminates.

The heating step is subsequently performed. The heating step includes a first heating step in which the chip laminate is heated at a relatively low first temperature for a first heating time, and a second heating step in which the chip laminate is heated at a second temperature higher than the first temperature for a second heating time after the first heating step is performed. The first temperature is equal to or higher than the decomposition temperature of the binder resin contained in the unfired conductor pattern formed on the magnetic sheets of the chip laminate (that is, the binder resin contained in the conductive paste), equal to or higher than the sintering onset temperature of the conductive particles contained in the unfired conductor pattern, and lower than the melting point of the inorganic material for the inorganic particles. The first temperature is, for example, in the range of 300° C. or higher and lower than 400° C. By elevating the temperature of the chip laminate to the first temperature, thermal decomposition of the binder resin in the unfired conductor pattern progresses. The first heating time is defined a time that the binder resin is sufficiently thermally decomposed, and is set to, for example, 2 to 10 hours. The heating time for heating at the first temperature can be appropriately changed depending on the content of the binder resin, the type of the binder resin, and other factors.

Since the first temperature is a temperature equal to or higher than the sintering onset temperature of the conductive particles, the sintering of the conductive particles also starts during the heat treatment performed at the first temperature. However, since the first temperature is lower than the melting point of the inorganic particles, the inorganic particles are not melted and remain between the conductive particles when heated at the first temperature. The inorganic particles hinder the progress of sintering of the conductive particles so that gaps remain between the conductive particles when heated at the first temperature. Products of the thermal decomposition of the binder resin, such as carbon dioxide, are discharged to the outside of the unfired conductor patterns through the gaps between the conductive particles during the heating step performed at the first temperature.

The second heating step is subsequently performed. In the second heating step, the chip laminate is heated to a second temperature, and a heat treatment is performed at the second temperature for a second heating time. In one or more embodiments of the invention, the second temperature may be in the range of 800 to 900° C. The second heating time is determined as a time sufficient for obtaining a dense sintered body, for example, 1 to 2 hours.

Next, the external electrode 21 and the external electrode 22 are formed on the surface of the chip laminate to which the heat treatment has been performed. Through the above steps, the coil component 1 including the conductor patterns formed from the conductive paste containing the inorganic particles can be obtained.

Alternatively, the coil component 1 may be manufactured by a method known to those skilled in the art other than the sheet manufacturing method, for example, a slurry build method or a thin film process method.

Advantageous effects of the above-described embodiment will be described in comparison with a conventional manufacturing method.

Organic particles or inorganic particles are not included in a conductive paste that contains conductive particles used in a conventional method of manufacturing a coil component. Thus, in the method of manufacturing a conventional coil component, during the heating step in which a laminated body of magnetic material sheets provided with conductor patterns formed from the conductive paste is heated, a binder resin in the conductive paste is thermally decomposed and sintering of the conductive particles progresses without being hampered by organic particles or inorganic particles. Therefore, the gaps between the conductive particles are reduced due to the progress of sintering of the conductive particles in the heating step, which lessens a chance of discharging the product (for example, carbon dioxide gas) of the thermal decomposition of the binder resin to the outside of the conductor paste. As a result, a large amount of binder resin residue is left in the sintered body of the conductive particles. The residue of the binder resin causes the sintered body to expand when the temperature of the laminated body is further elevated in the heating step. As the sintered body of the conductive particles expands in the conductor pattern, cracks may occur in the magnetic material adjacent to the conductor pattern and the cracks may run toward the surface of the coil component. Further, when the temperature of the laminate is further increased in the heating step, the sintered body of the conductive particles is further densified in the conductor pattern. Since the sintered body shrinks when it is densified, the conductor pattern expands once and then shrinks in the heating step. The shrinkage of the conductor pattern may cause cracks in the magnetic layer between the two conductor patterns in the laminate. Moreover, the shrinkage of the conductor pattern may cause delamination of the magnetic layer adjacent to the conductor pattern from the conductor pattern.

In the method for manufacturing the coil component 1 according to one or more embodiments of the invention, the thermal decomposition of the binder resin causes the sintering of the conductive particles to start in the first heating step. In the first heating step, since the organic particles are present between the conductive particles without being thermally decomposed, or since the inorganic particles are present between the conductive particles without being melted, the progress of sintering of conductive particles is hindered as compared with the conventional manufacturing method in which organic or inorganic particles are not present. Thus the conductive particles do not become a dense sintered body in the first heating step, so that the products of the thermal decomposition of the binder resin such as carbon dioxide pass through the grain boundaries of the conductive particles and are discharged to the outside of the conductive paste in the first heating step. Sintering of the conductive particles is promoted in the second heating step in which the heat treatment is performed at the higher second temperature, and a dense sintered body is obtained through the second heating step. According to one or more embodiments of the invention, the discharge of the binder resin to the outside of the conductive paste is promoted as described above, so that the amount of the residue of the binder resin remaining in the sintered body can be reduced and consequently the expansion of the sintered body can be suppressed. Thus, in the finished coil component 1, it is possible to prevent occurrence of cracks in the magnetic layers 11 to 17 adjacent to the conductor patterns C11 to C16 respectively, and delamination between the conductor patterns C11 to C16 and the adjacent magnetic material layers 11 to 17.

In one or more embodiments of the invention, a thickness of each of the conductor patterns C11 to C16 is greater than a spacing between respective adjacent conductor patterns C11 to C16. Therefore, the direct current resistance of the coil conductor 25 can be reduced. When the conductive paste is applied thickly to the magnetic sheet in the manufacturing process in order to form a thick conductor pattern, a larger stress acts on the magnetic sheet due to the expansion of the sintered body during heating. For this reason, it was difficult to form a thick conductor pattern, and in particular, it was difficult to make the conductor pattern thicker than the distance between the two adjacent conductor patters C11 to C16 in a coil component manufactured by the conventional manufacturing method. In the manufacturing method according to one or more embodiments of the invention, the expansion of the sintered body that forms the conductor pattern can be suppressed, so that the stress acting on the magnetic sheet is reduced as discussed above. Therefore, in one or more embodiments of the invention, it is possible to fabricate a thick conductor pattern to reduce the DC resistance value of the coil conductor.

When the proportion of the conductive particles in the conductive paste is increased, the voids between the conductive particles are reduced so that a large amount of residue is left in the conductor pattern according to the conventional manufacturing method. Whereas by the manufacturing method according to one or more embodiments of the invention, it is possible to manufacture a coil component having the conductor pattern in which few residues and voids left therein even when the proportion of the conductive particles in the conductive paste is high. As a result, by the manufacturing method according to one or more embodiments of the invention, a coil component having few residues and voids in the conductor pattern can be obtained. The coil component realizes a high conductivity because there are few residues and voids in the conductor pattern.

The coil component fabricated by the manufacturing method according to one or more embodiments of the invention have few residues and voids in the conductor pattern, so that regions where these residues and voids are present are not connected to each other during the manufacturing process. Thus, when such a coil component manufactured by the manufacturing method according to one or more embodiments of the invention is viewed in cross section, the voids in the conductor pattern are looked as substantially spherical.

The coil component manufactured by the method of manufacturing a coil component according to one or more embodiments of the invention has cross sections of the conductor patterns C11 to C16 cut along the coil axis Ax, and upper and lower regions of each cross section of the corresponding conductor patter in the thickness direction (along the T axis) include more voids than an intermediate region between the upper and lower regions. For example, when the conductor pattern C11 is divided into three equal parts in the thickness direction, an uppermost region thereof is defined as the upper region, a lowermost region is defined as the lower region, and a region sandwiched between the upper region and the lower region is defined as the intermediate region. For example, the ratio of the area occupied by the voids in the upper region of the conductor pattern C11 to the total area of the upper region may be larger than the ratio of the area occupied by the voids in the intermediate region to the total area of the intermediate region. Further, the ratio of the area occupied by the voids in the lower region of the conductor pattern C11 to the total area of the lower region may be larger than the ratio of the area occupied by the voids in the intermediate region to the total area of the intermediate region. The description of the area of the voids may also apply to voids present in the conductor patterns C12 to C16.

The dimensions, materials, and arrangements of the constituent elements described herein are not limited to those explicitly described for the embodiments, and these constituent elements can be modified to have any dimensions, materials, and arrangements within the scope of the present invention. Furthermore, constituent elements not explicitly described herein can also be added to the described embodiments, and it is also possible to omit some of the constituent elements described for the embodiments.

One or more of the steps of the manufacturing method described herein can be omitted as appropriate as long as there is no contradiction. In the manufacturing method described herein, steps not described explicitly in this specification may be performed as necessary. One or more of the steps included in the above-described manufacturing method may be performed in different orders without departing from the spirit of the invention. Some of the steps included in the above-described manufacturing method may be performed at the same time or in parallel, if possible.

What is claimed is:

1. A method of manufacturing a coil component, comprising:
a step of forming, on a magnetic sheet, a conductor pattern from a conductive paste that contains conductive particles, organic particles made of an organic material, and a binder resin;
a step of laminating a plurality of magnetic sheets on which the conductor pattern has been formed to obtain a laminate;
a first heating step of heating the laminate at a first temperature, the first temperature being equal to or higher than a decomposition temperature of the binder resin, equal to or higher than a sintering onset temperature of the conductive particles, and lower than a thermal decomposition temperature of the organic particles; and
a second heating step of heating the laminate at a second temperature, the second temperature being higher than the thermal decomposition temperature of the organic particles.

2. The method according to claim 1, wherein the organic material is an acrylic resin.

3. The method according to claim 1, a content ratio of the organic particles to a total mass of the conductive particles and the organic particles is 1.0 to 5.0 wt %.

4. The method according to claim 1, wherein the second temperature is 800° C. or higher.

5. A method of manufacturing a coil component, comprising:
a step of forming, on a magnetic sheet, a conductor pattern from a conductive paste that contains conductive particles, inorganic particles made of an inorganic material, and a binder resin;
a step of laminating a plurality of magnetic sheets on which the conductor pattern is formed to obtain a laminate;
a first heating step of heating the laminate at a first temperature, the first temperature being equal to or higher than a decomposition temperature of the binder resin, equal to or higher than a sintering onset temperature of the conductive particles, and lower than a melting point of the inorganic particles; and
a second heating step of heating the laminate at a second temperature, the second temperature being higher than the first temperature.

6. The method according to claim 5, the inorganic material is zirconia.

7. The method according to claim 5, wherein a content ratio of the inorganic particles to a total mass of the conductive particles and the inorganic particles is 0.05to 0.15 wt %.

8. The method according to claim 5, wherein the laminate is heated at 800° C. or higher in the heating step.

9. The method according to claim 1, wherein the plurality of magnetic sheets include a first magnetic sheet and a second magnetic sheet disposed on the first magnetic sheet,
wherein a first conductor pattern is formed from the conductive paste on an upper surface of the first magnetic sheet, and a second conductor pattern is formed from the conductive paste on an upper surface of the second magnetic sheet, and
wherein a thickness of the first conductor pattern is larger than a distance between the first conductor pattern and the second conductor pattern.

10. The method according to claim 1, wherein the conductive particles are silver particles.

11. The method according to claim 1, further comprising a step of providing a first external electrode at one end of the conductor pattern and providing a second external electrode at the other end of the conductor pattern.
